(19) United States
(12) Patent Application Publication
(10) Pub. No.: US 2022/0227559 A1
(43) Pub. Date: Jul. 21, 2022

(54) CUSTOM-MADE CORRUGATED EDGE PROTECTORS

(71) Applicant: Packsize LLC, Salt Lake City, UT (US)

(72) Inventor: Arthur Y. Tsubaki, Herriman, UT (US)

(21) Appl. No.: 17/648,529

(22) Filed: Jan. 20, 2022

Related U.S. Application Data
(60) Provisional application No. 63/140,163, filed on Jan. 21, 2021.

(51) Int. Cl. B65D 81/05; G06F 30/10; G06K 7/14

(52) U.S. Cl. CPC B65D 81/054; G06K 7/1404; G06F 30/10

(57) ABSTRACT

A computer system for creating custom-made corrugated edge protectors receives one or more product protection variables. The system also determines one or more corrugated edge protector attributes based upon the one or more product protection variables. Additionally, the system generates a construction command that is configured to cause a packaging production machine to create a custom-made corrugated edge protector. The system also sends the construction command to the packaging production machine. The construction command causes the packaging production machine to create the custom-made corrugated edge protector.

### CROSS-REFERENCE TO RELATED APPLICATIONS

This application claims priority to U.S. Provisional Patent Application No. 63/140,163, entitled “CUSTOM-MADE CORRUGATED EDGE PROTECTORS,” filed on Jan. 21, 2021, which is incorporated herein by reference in its entirety.

### BACKGROUND

Shipping and packaging industries frequently use wooden pallets to both assist in transporting and protecting products during transport. The hard, wooden edges of the pallets may protect the more fragile edges of shipped products. For example, a tabletop may be shipped on a wood pallet. As long as the wood pallet extends beyond the edges of the tabletop, the edges of the tabletop may enjoy some protection from damage. Similar protections can be provided through the use of foam or rubber corners guards that can be placed on the corners and/or edges of fragile objects during transportation.

Also, in some cases, product contained within boxes, such as tabletops, doors, windows, fragile items, etc., will need to be protected. Many of these products are bulky and/or heavy enough that it is awkward for an individual to carry. In these cases, it is desirable to protect the product in case the product is accidently dropped or placed on its edge. The pressure on the edge, without protection, may be sufficient to cause damage.

The various protective components, however, are often environmentally detrimental and difficult to manage. Many of these protective components are constructed from materials that are not easily recyclable. Additionally, many of these protective components consume a lot of shipping space—both when products are delivered and then again when the protective components, such as pallets, have to be retrieved after products are unpacked. Further, many of these protective components are not customizable in ways that maximize both protection and shipping considerations. For example, in some cases a wooden pallet may far exceed the needed dimensions to protect a particular product—nonetheless, the product may need to be shipped on the pallet to avoid damage to the product itself. Similarly, dunnage materials, such as air pillows, foam peanuts, or other protective material, require time and care when placing with a product to ensure that the product is properly protected.

In view of these, and other, deficiencies in the art, there is a need for better solutions relating to the creation and management of protective components for shipping. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems, methods, and computer-readable media for creating custom-made corrugated edge protectors. Disclosed embodiments may comprise one or more processors and one or more computer-readable media having stored thereon executable instructions that when executed by the one or more processors configure the computer system to create custom-made corrugated edge protectors. The system receives one or more product protection variables. The one or more product protection variables comprise one or more of the following: a product dimension, a product fragility rating, and/or a product weight. The system also determines one or more corrugated edge protector attributes based upon the one or more product protection variables. The one or more corrugated edge protector attributes comprise one or more of the following: a corrugated type, a number of internal support members, or a dimension of a corrugated channel. Additionally, the system generates a construction command that is configured to cause a packaging production machine to create a custom-made corrugated edge protector. The construction command comprises instructions that are based upon the one or more corrugated edge protector attributes. The custom-made corrugated edge protector is configured to protect one or more edges of a target product during shipping and handling. The system also sends the construction command to the packaging production machine. The construction command causes the packaging production machine to create the custom-made corrugated edge protector.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings described below.

FIG. 1 illustrates a schematic of an embodiment of a packaging system.

FIG. 2 illustrates a schematic diagram of a system for creating custom protective components.

FIG. 3 illustrates an embodiment of custom-made corrugated edge protectors.

FIG. 4 illustrates another view of the custom-made corrugated edge protectors of FIG. 3.

FIG. 5 illustrates an embodiment of a portion of corrugated that has been creased for folding into a custom-made corrugated edge protector.

FIG. 6A illustrates an embodiment of custom-made corrugated edge protectors.

FIG. 6B illustrates another embodiment of custom-made corrugated edge protectors.

FIG. 6C illustrates yet another embodiment of custom-made corrugated edge protectors.

FIG. 6D illustrates yet another embodiment of custom-made corrugated edge protectors.

FIG. 7 illustrates a target product surrounded by embodiments of custom-made corrugated edge protectors.

FIG. 8 illustrates a flow chart of an embodiment of a method for creating custom-made corrugated edge protectors.

### DETAILED DESCRIPTION

Disclosed embodiments include technological solutions for creating custom-made corrugated edge protectors. One will appreciate that such a system utilizes complex network communications, memory space management within queues, packaging-production machine management, and other related technologies.

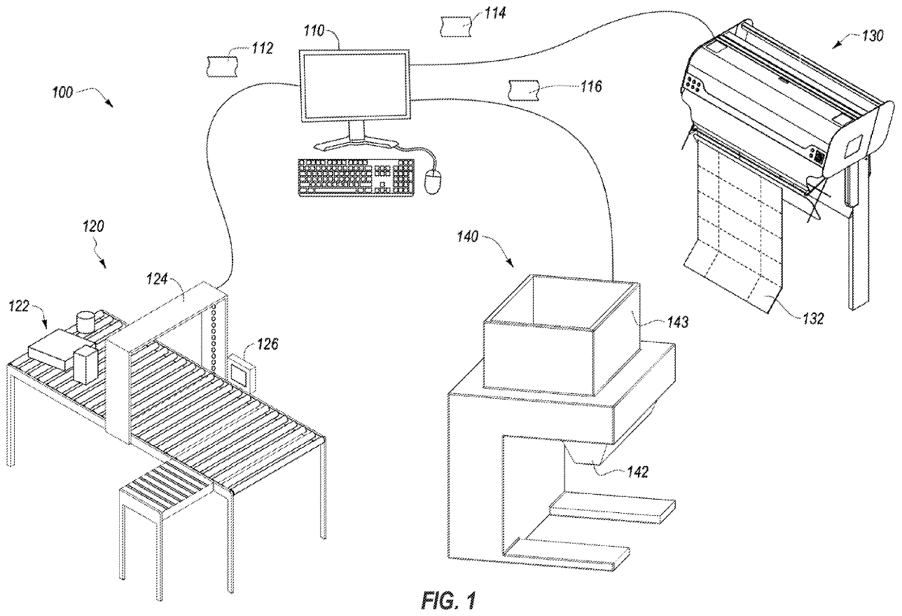

Turning now to the figures, FIG. 1 illustrates a schematic diagram of an embodiment of a packaging system 100. The depicted packaging system 100 comprises various exemplary components, including an embodiment of a packaging system control unit 110, an embodiment of a product intake system 120, an embodiment of a packaging-production machine 130, and an embodiment of a void fill/dunnage-production machine 140. The various components and modules of packaging systems 100 described herein are provided only for the sake of clarity and example. One of skill in the art will understand that various alternative or additional modules or components can be used equivalently to the same effect. For example, multiple packaging system control units 110, product intake systems 120, packaging-production machines 130, and/or void fill/dunnage-production machines 140 can be used within the scope of the present disclosure.

In at least one embodiment, a picking system (not shown) provides a group of one or more target products 122 (also referred to herein as “objects”) to the product intake system 120. The depicted product intake system 120 comprises a conveyor belt configured to transport the target products 122 through at least a portion of the packaging system 100. Additionally, the product intake system 120 may comprise dimensional input devices 124, in the form of one or more scanning sensors. In at least one embodiment, the one or more scanning sensors comprise a light curtain. The light curtain uses various light emitters and light detectors to measure both the height and width of the target products 122.

The depicted light curtain is provided only for the sake of example. In various alternative or additional embodiments, the product intake system comprises multiple dimensional input devices 124, such as light curtains for measuring different cross-sections of the group of one or more target products 122. Further, in additional or alternative embodiments, the product intake system 120 comprises other one or more dimensional input devices 124 for determining the dimensions of the target products 122. For example, the one or more dimensional input devices 124 may comprise a URL scanner 126 that scans a URL associated with each of the target products within the group of one or more target products 122. The URL scanner 126 may be in communication with a computer database (not shown) that stores the dimensional information for each product based upon its URL. The product intake system 120 may also comprise other sensors, such as a scale to determine the weight of the target products 122.

The URL scanner 126 is provided for the sake of example, in various embodiments, a barcode scanner, RFID scanner, QR scanner, OCR scanner, or any number of different scanners may be used. The scanner is configured to gather information about the scanned target. The information may comprise a product identifier that can be used to access product characteristics about the product from a digital database. Additionally or alternatively, the product characteristics may be directly gathered by the scanner. For instance, the scanner may be a QR code scanner and the product characteristics may be directly integrated within the QR code itself. In various embodiments, the product characteristics comprises product dimensions, product weight, product fragility ratings, product characteristics, and other information of interest relating to the product.

Similarly, the one or more dimensional input devices 124 may comprise devices for receiving manually entered dimension information, manually entered product description information, or any other manually entered information that allows the packaging system 100 to access a database and determine a packaging template size required to package the target products 122. In such a case, the product intake system 120 determines the overall dimensions of all the groups of one or more target products 122 based upon the stored dimensions of each individual product. Additionally or alternatively, the one or more dimensional input devices 124 can comprise a LIDAR sensor, a computer vision system, a laser distance measuring sensor, or any other system capable of measuring dimensions. Accordingly, various different apparatus and systems can be used to determine the dimensions of the group of one or more target products 122.

Further, in at least one embodiment, it is not necessary for a product intake system 120 to be present within the packaging system. For example, in some embodiments, users may simply provide inputs to the packaging system control unit 110 indicating a particular custom packaging design template. As used herein, a “packaging design template” refers to the digital and/or physical design that is converted into a physical corrugated box, such as an unfolded corrugated box template. As such, in some cases, the packaging design template describes the digital file that corresponds to the physical design of the corrugate, while in other embodiments the packaging design template describes the cut and creased corrugated that is ready to be folded and glued into a box. The packaging system control unit 110 communicates a command to the packaging production machine 130 to generate the requested custom packaging design template.

Once the product intake system 120 determines information relating to the physical dimensions of the group of one or more target products 122, the product intake system 120 communicates the information to the packaging system control unit 110. Alternatively, a user can manually enter in the requested packaging design, dimensions, quantity, and other package characteristics.

The packaging system control unit 110 may comprise a server, a desktop computer, an embedded system, a microcontroller, a cloud server, or any other computing device capable of communicating and processing information. The packaging system control unit 110 comprises a packaging database that contains various information relating to the packaging production system and to the one or more target products 122. For example, the packaging database includes information about available corrugated types, available packaging-production machines 130, available dunnage types, available void fill/dunnage-production machines 140, types of products that are to be packaged (e.g., the one or more target products 122), physical characteristics of the products to be packaged, special packaging needs associated with specific products, and other similar information.

In at least one embodiment, a cache of packaging design templates is stored near the product intake system 120. In such an embodiment, when the overall dimensions of an order are identified, an appropriate packaging design template may be immediately retrieved from the cache. A replacement packaging template design template can then be generated and placed in the cache to replace the previously removed packaging design template.

In at least one embodiment, the packaging system control unit 110 sends commands to the packaging production machine 130 that cause the machine to generate a custom-made packaging design template. The custom-made packaging design template may be produced to specially fit the one or more target products 122 or make the requested box size. Additionally, in at least one embodiment, the packaging system control unit 110 selects the particular packaging production machine 130 and corrugated that will be used to create the packaging design template. As such, the packaging system control unit 110 exercises significant control over the dimensions and materials that are used in the construction of a custom-made packaging design template.

The packaging production machine 130 comprises any machine capable of producing custom packages, package templates, or custom made protective components. As used herein “protective components” include edge protectors, corner protectors, surface protectors, or any other physical component meant to protect the structure and/or aesthetic integrity of target products 122. The packaging production machine 130 is also associated with at least one type of bulk corrugated. For example, a packaging production machine 130 may be associated with a relatively thinner and/or a relatively thicker corrugate, or a variety of grades loaded at once. Additionally, different corrugated may have different strength characteristics, different production costs, different shipping costs, and various other different characteristics.

In at least one embodiment, the packaging system control unit 110 is also in communication with a void fill/dunnage production machine 140. The dunnage production machine 140 comprises any machine that is capable of automatically creating, measuring, and/or forming dunnage. For example, the depicted dunnage production machine 140 is configured to dispense from a hopper 143 a measured amount of foam peanuts. The foam peanuts are dispensed from a nozzle 142 into a target package. In additional or alternative embodiments, the dunnage production machine 140 is configured to create, measure, and/or form wood, matting, bubble wrap, air pillows, foam, cardboard, paper, plastic, mold formed cushioning, or any other type of material capable of functioning as dunnage.

One will appreciate that the above described packaging system 100 is provided for context and clarity purposes. In various other embodiments, the packaging system 100 may comprise different components, different machines, or may be combined into a single machine that performs any number of the above referenced functions.

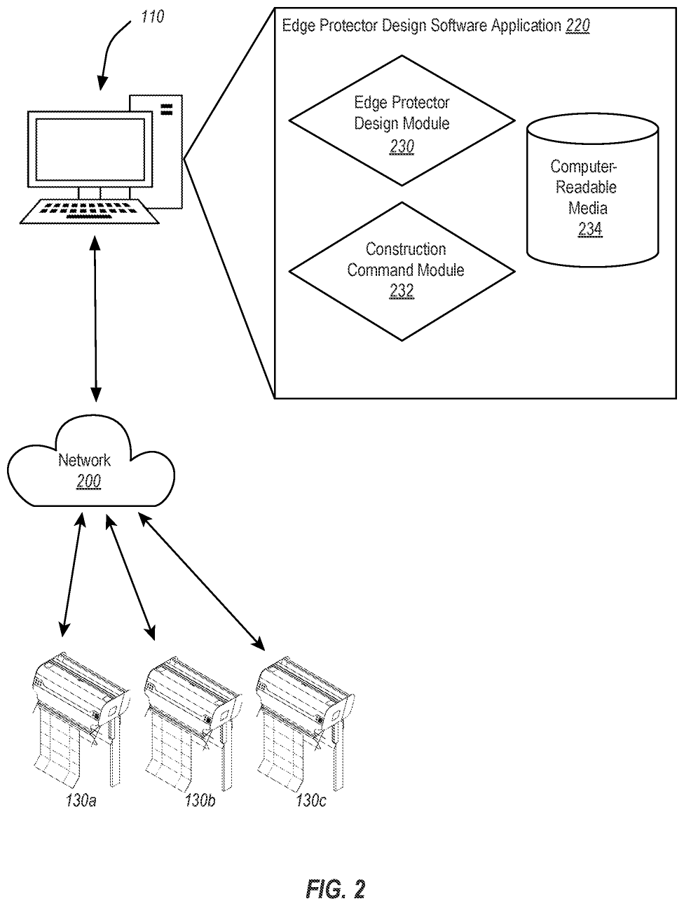

FIG. 2 illustrates a schematic diagram of a system for creating custom protective components. The system comprises a computer, such as the packaging system control unit 110, but may be executed on any computer, both local and/or remote. The packaging system control unit 110 communicates with packaging production machines 130(a-c) through a network 200. The packaging system control unit 110 executes an edge protector design software application 220 that is configured to cause the packaging production machines 130(a-c) to create protective components, such as corrugated edge protectors.

As depicted, the edge protector design software application 220 may comprise an edge protector design module 230, a construction command module 232, and a computer-readable media 234, also referred to herein as “computer storage media.” As used herein, a “module” comprises computer executable code and/or computer hardware, such as a processor, that performs a particular function. One of skill in the art will appreciate that the distinction between different modules is at least in part arbitrary and that modules may be otherwise combined and divided and still remain within the scope of the present disclosure. As such, the description of a component as being a “module” is provided only for the sake of clarity and explanation and should not be interpreted to indicate that any particular structure of computer executable code and/or computer hardware is required, unless expressly stated otherwise. In this description, the terms “component”, “agent”, “manager”, “service”, “engine”, “virtual machine”, PLC or the like may also similarly be used. One will appreciate that all or portions of the packaging system control unit 110 may be executed and stored within a stand-alone computer, a cloud-based computer, a combination of the preceding, or within processing units integrated within the packaging production machines 130(a-c).

The packaging system control unit 110 of FIG. 2 comprises one or more processors and one or more computer-readable media 234 having stored thereon executable instructions that when executed by the one or more processors configure the computer system to create custom-made corrugated edge protectors. In at least one embodiment, the edge protector design software application 220 receives one or more product protection variables. The one or more product protection variables may comprise one or more of the following: a product dimension, a product fragility rating, or a product weight.

The product protection variables may be received through the network 200 from sensors 126, such as the dimensional input devices 124 or the URL/barcode scanner. Accordingly, in at least one embodiment, the sensor 126 may scan a barcode associated with the target product 122. The edge protector design software application 220 then accesses a database of item characteristics using the barcode. The database may be stored locally within the computer-readable media 234 or external to the edge protector design software application 220.

In an additional or alternative embodiment, the product protection variables may be pre-stored within the database and retrieved on a per order basis, such that no sensors 126 are needed to acquire the product protection variables. For example, an order may be received by a customer through the internet. Upon receiving the order, the product protection variables may be automatically gathered from a database of item characteristics based upon the products that the customer ordered.

The product fragility rating may comprise a predetermined product fragility rating that is directly integrated within a barcode associated with the target product, stored within a database that is external to the edge protector design software application 220, or stored within the computer-readable media 234. In at least one embodiment, the manufacturer or provider of the target product manually assigns product fragility ratings to their products based upon the product fragility scale.

The product fragility rating may be based upon a predetermined scale (e.g., 1-10) that indicates the ease with which damage can occur to a target product. For instance, the product fragility rating may account for the type of material that a target product is constructed of, such that a glass product may have a higher fragility rating than a steel product. The product fragility rating may also account for the weight of the product itself in view of its construction. For instance, a small and relatively light object made out of glass may be associated with a lower product fragility rating than a large and heavy object that is also made out of glass. The product fragility rating may account for the extra weight during transport in determining that the large heavy object may need greater protection.

Upon receiving the one or more product protection variables, the edge protector design module 230 determines one or more corrugated edge protector attributes based upon the one or more product protection variables. The one or more corrugated edge protector attributes may comprise one or more of the following: a corrugated type, a number of internal support members, and/or a dimension of a corrugated channel. For example, the edge protector design module 230 may determine that an object with a high product fragility rating and a high weight should utilize a thicker, heavier type of corrugated. As such, the edge protector design module 230 may select from the available corrugated, the thickest and heaviest available. Similarly, the edge protector design module 230 may determine that an object that comprises a relatively low weight only requires a thinner corrugated grade.

Additionally, the edge protector design module 230 may determine one or more corrugated edge protector attributes by identifying a set of available corrugated types. One will appreciate that each corrugated type within the set of available corrugated types comprises unique strength characteristics. The edge protector design module 230 maps a weight of the target product to a particular corrugated type based upon a set of corrugated strength thresholds. The corrugated strength thresholds may be provided by a database of thresholds or by an algorithm. The edge protector design module 230 incorporates the particular corrugated type into the one or more corrugated edge protector attributes.

As a further example, the edge protector design module 230 may determine a number of support members that are included within the protective component. As used here, support members comprise folds within the corrugated (also referred to herein as “Z's” or “z-folds”) and/or corrugated strips. In both cases the Z's and/or the corrugated strips are placed within a channel that is also formed from corrugated. The dimensions of the channel, the Z's, and the corrugated strips are determined by the edge protector design module 230 based upon the one or more corrugated edge protector attributes, the one or more product protection variables, and the dimensions of the target product(s).

For example, edge protector design module 230 may map the product fragility rating to a particular number of internal support members. For instance, the edge protector design module 230 may comprise a database that indicates a number of internal support members that should be associated with each respective level within the product fragility ratings. The database may also account for the type of corrugated being used and/or the weight of the target product. For instance, the database may indicate that a product with a fragility rating of “10” and a weight within a particular threshold range requires a type of corrugated that exceeds a particular threshold thickness and further requires at least three internal support members. The database may also indicate that if only types of corrugated that comprise less than the desired thickness are available then five internal support members are required. The edge protector design module 230 utilizes this information to incorporate the particular number of internal support members within the one or more corrugated edge protector attributes.

For example, the edge protector design module 230 may determine that with a material 44C, it can fit 3 “Z's” within a channel having dimensions of 1.25 inches to 1.5 inches tall. Similarly, the edge protector design module 230 may determine that a channel having dimensions of 1 inch to 1.25 inches tall may have 2 “Z's” with the 44C material. In at least one embodiment, the edge protector design module 230 may hold the width of the channel at 2 inches. As such, the edge protector design module 230 may only need to account for the variables of the material thickness (thinner material may need more or less Z's) and the height of the portion of the target product that is to be protected. In at least one embodiment, the edge protector design module 230 may also account for the weight of the product, which would allow the edge protector design module 230 to choose different grades of corrugated to use to protect the product. Heavier items may need heavier grades of corrugated.

Additionally, in at least one embodiment, the edge protector design module 230 may add in the material height to modify a pair of the edge protectors (i.e., those that go on either opposite end). For example, the pair of edge protectors may be layered on top of other perpendicularly laid corrugate, as such, the edge protector design module 230 may need to increase the height of the edge protector by ⅛ inch, for example, if the corrugated grade thickness is also ⅛ inch. This ensures that the edge protector is of the proper height to always accommodate the object it is protecting.

Once the edge protector design module 230 has determined the one or more corrugated edge protector attributes, the construction command module 232 generates a construction command that is configured to cause a packaging production machine 130(a-c) to create a custom-made corrugated edge protector. The construction command comprises instructions that are based upon the one or more corrugated edge protector attributes. The custom-made corrugated edge protector is configured to protect one or more edges of a target product 122 during shipping. In at least one embodiment, the packaging production machines 130(a-c) comprise machines that are capable of creating box templates. Alternatively, in at least one embodiment, the packaging production machines 130(a-c) comprise machines that are purposely made to create corrugated edge protectors.

The construction command module 232 also sends the construction command to the packaging production machine 130(a-c). The construction command causes the packaging production machine 130(a-c) to create the custom-made corrugated edge protector. Various disclosed embodiments provide significant benefits to that art. For example, disclosed embodiments reduce reliance on unsustainable products such as plastic and synthetic waste that are conventionally used for creating protective components. Moreover, disclosed embodiments comprise the advantage that they can be produced as required from a length of continuous cardboard, which leads to an effective and economic external packaging which is also fully recyclable.

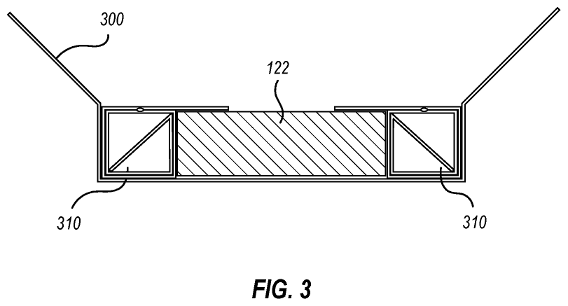

Turning now to various examples of protective components, FIG. 3 illustrates an embodiment of custom-made corrugated edge protectors 310 that surround a target product 122 and are enclosed by a corrugated package 300. One will appreciate that while FIG. 3 depicts a corrugated package 300, in at least one embodiment, the corrugated edge protectors 310 may be used without a corrugated package 300. Additionally, one will appreciate that the target product 122 may comprise any number of different items, including but not limited to, a furniture front, a furniture part, a worktop, a tabletop, a door leaf, a window glass, a ceramic plate or the like.

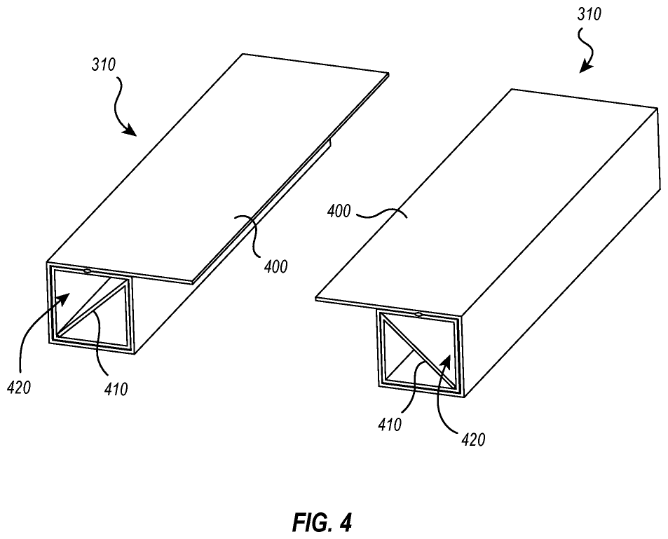

FIG. 4 illustrates another view of the custom-made corrugated edge protectors 310 of FIG. 3. In the depicted embodiment, the custom-made corrugated edge protectors 310 comprise a positioning flap 400 that covers the top of the target product 122. While not required, the positioning flap 400 may assist in keeping the custom-made corrugated edge protectors 310 properly aligned with the target product and may also provide additional protection to an upper surface of the target product 122.

FIG. 4 also depicts an embodiment of a support member 410 within a channel 420 of the custom-made corrugated edge protectors 310. The depicted support members 410 comprise a Z, or a fold in the corrugated, that provide additional structural strength to the custom-made corrugated edge protectors 310. As discussed further herein, the support members 410 may comprise a variety of different forms, including but not limited to Z's and corrugated strips.

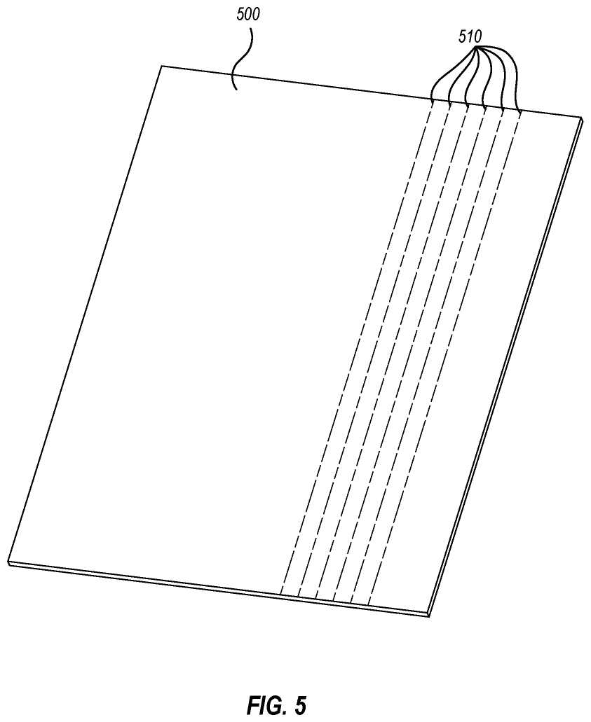

FIG. 5 illustrates an embodiment of a portion of corrugated 500 that has been creased for folding into a custom-made corrugated edge protector 310. The depicted corrugated 500 has been processed by a packaging production machine 130(a-c), which has left creases 510 on the surface of the corrugated 500. The creases 510 may comprise indentations and/or shallow cuts or full-depth cuts with adequate spacing between the cuts made into the corrugated 500 itself. Once creased, the corrugated 500 can be folded by machine or by human interaction, into the custom-made corrugated edge protectors 310.

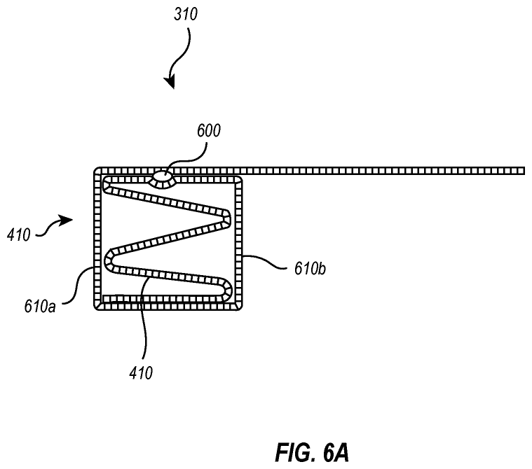

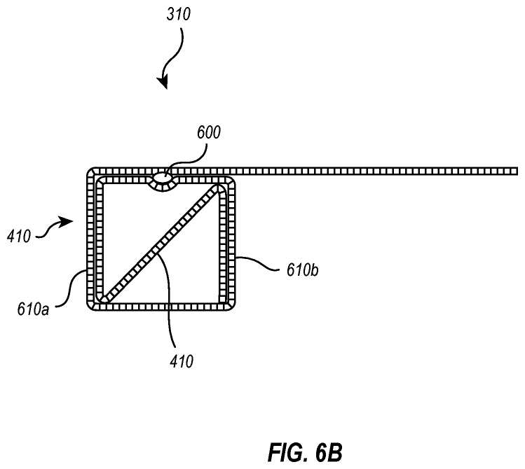

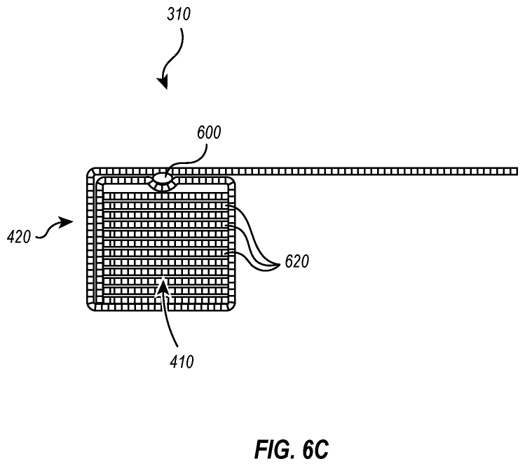

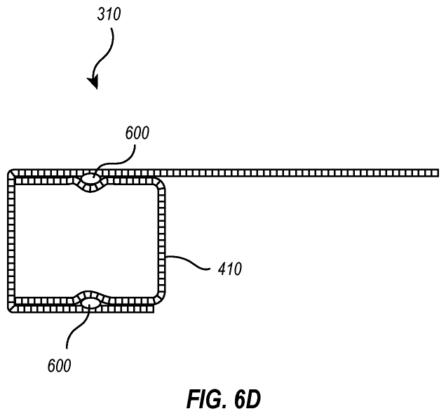

FIG. 6A-6D show various different embodiments of custom-made corrugated edge protectors 310 with differing support members 410. For example, FIG. 6A depicts a custom-made corrugated edge protector 310 with a channel 420 that comprises a number of internal support members 410 in the form of multiple Zs. The specific number of support members 410 (i.e., z-folds) may be determined based upon the fragility rating of the associate product. Of note, the channel 420 in FIG. 6A comprises outer walls 610(a, b) that are only a single layer of corrugated thick. Additionally, FIG. 6A depicts an adhesive element 600, such as glue, that holds the custom-made corrugated edge protector 310 together.

FIG. 6B depicts another custom-made corrugated edge protector 310 with a channel 420 that comprises an internal support member 410 in the form of a Z. Of note, the channel 420 in FIG. 6B comprises outer walls 610(a, b) that are two layers of corrugated thick. Additionally, FIG. 6B depicts an adhesive element 600, such as glue, that holds the custom-made corrugated edge protector 310 together. Accordingly, the custom-made corrugated edge protector 310 may be designed with specific corrugated types, layers of walls, and various support members.

FIG. 6C depicts yet another custom-made corrugated edge protector 310 with a channel 420 that comprises an internal support member 410 in the form of corrugated strips 620. In the depicted embodiment, the corrugated strips 620 are stacked vertically, however, in alternative embodiments, the corrugated strips may be stacked horizontally. The direction of stacking may be determined based upon the one or more corrugated edge protector attributes. Additionally, FIG. 6C depicts an adhesive element 600, such as glue, that holds the custom-made corrugated edge protector 310 together. In at least one embodiment, the internal support member 410 may comprise a single piece of corrugated that is creased in a manner to fold back and forth like multiple z's that would fill up the channel.

FIG. 6D depicts yet another custom-made corrugated edge protector 310 with two halves of shaped corrugated placed together to form an edge protector. In this depicted embodiment, the internal support member 410 comprises a U-shaped folded corrugated internal channel. Additionally, FIG. 6D depicts an adhesive element 600, such as glue, that holds the custom-made corrugated edge protector 310 together.

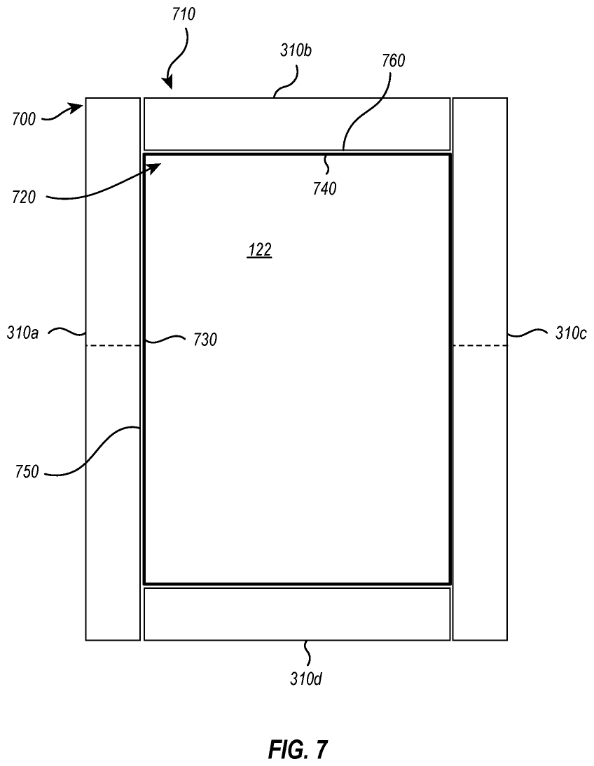

FIG. 7 illustrates a target product 122 surrounded by embodiments of custom-made corrugated edge protectors 310(a-d). Returning also to the edge protector design software application 220 of FIG. 2, the edge protector design module 230 may receive dimensions describing a perimeter of the target product 122. The perimeter comprises at least a first product length of first side 730 and a second product length of a second side 740. In the depicted example, the second side 740 is consecutive to the first side 730.

The edge protector design module 230 calculates a first-corrugate-edge-protector length 750 that is greater than the first-product length of the first side 730 and a second-corrugate-edge-protector length 760 that is less than or equal to the second product length of the second side 740. The first-corrugate-edge-protector length 750 describes a length of a first channel of the custom-made corrugated edge protector 310a, and the second-corrugate-edge-protector length 760 describes a length of a second channel of the custom-made corrugated edge protector 310b.

In at least one embodiment, the target product 122 comprises a tabletop and the custom-made corrugated edge protectors 310(a-d) comprise four physically separate corrugated channels that each extend along a length of a respective side of the tabletop. Additionally, as indicated above, the custom-made corrugated edge protector 310a may extend past the upper-left edge 720 of the target product 122, while the custom-made corrugated edge protector 310b may only extend to the upper-left edge 720 of the target product 122. As such the end 700 of the custom-made corrugated edge protector 310a extends past the end 710 of the custom-made corrugated edge protector 310b. Such a configuration may provide protection to the upper-left edge 720 of the target product 122 by completely enclosing it with custom-made corrugated edge protectors 310(a, b). In some embodiments, 310 (a, b) may also be created in multiple pieces depending on length of the object 122—for example, if the packaging production machine 130 is not able to create a single length piece to cover the entire product 122 edge.

As depicted, in some embodiments multiple, distinct custom-made corrugated edge protectors 310(a-d) are placed around the target product 122. Additionally or alternatively, a single custom-made corrugated edge protector 310 may be formed such that it wraps around the entire perimeter of the target product 122. Further, in at least one embodiment, one or more sides of the target product 122 may be protected by multiple, distinct custom-made corrugated edge protectors 310(a-d). For instance, custom-made corrugated edge protectors 310a and 310c are shown with a dashed line indicating a possible division between separate upper and lower custom-made corrugated edge protectors on each respective side. Similarly, when generating the construction command, the construction command module 232 may include at least one height measurement that causes the packaging production machine 130 to create a custom-made corrugated edge protector 310 of a particular height, wherein the at least one height measurement is based upon a height of the target product 122.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

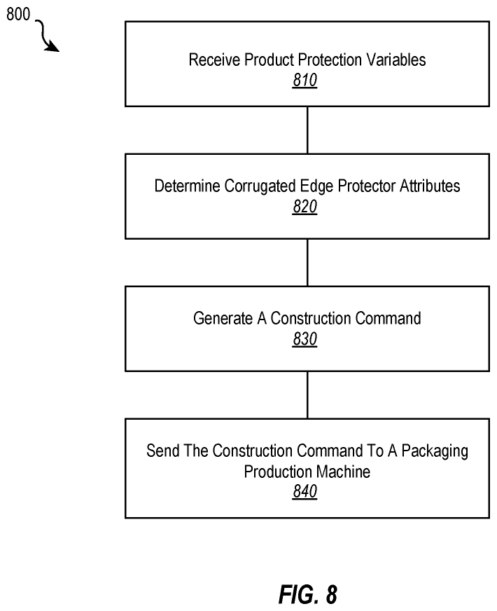

FIG. 8 illustrates a flow chart of an embodiment of a method 800 for creating custom-made corrugated edge protectors 310. The method 800 includes an act 810 of receiving product protection variables. For example, as depicted and described with respect to FIGS. 1 and 2, a barcode scanner 126 can scan a target product. Based upon the scanned barcode, the edge protector design module 230 can access a database and receive one or more product protection variables. The one or more product protection variables may comprise one or more of the following: a product dimension, a product fragility rating, or a product weight.

Additionally, method 800 may comprise an act 820 of determining corrugated edge protector attributes. Act 820 includes determining one or more corrugated edge protector attributes based upon the one or more product protection variables, wherein the one or more corrugated edge protector attributes comprise one or more of the following: a corrugated type, a number of internal support members, or a dimension of a corrugated channel. For example, as depicted and described with respect to FIGS. 1 and 2, the edge protector design module 230 can access threshold information and/or algorithmic information from the computer-readable media 234. Using this information, the edge protector design module 230 generates corrugated edge protector attributes.

Method 800 also may comprise an act 830 of generating a construction command. Act 830 includes generate a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping. For example, as depicted and described with respect to FIGS. 1 and 2, the construction command module 232 generates a command that causes a packaging production machine 130(a-c) to generate a custom-made corrugated edge protector.

Further, method 800 may comprise an act 840 of sending the construction command to a packaging production machine. Act 840 includes sending the construction command to the packaging production machine, the construction command causing the packaging production machine to create the custom-made corrugated edge protector. For example, as depicted and described with respect to FIGS. 1 and 2, the construction command module 232 sends the construction command to a packaging production machine 130(a-c), which causes the packaging production machine 130(a-c) to generate a custom-made corrugated edge protector.

Further, the methods may be practiced by a computer system or PLC system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc., for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, PLCs, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention thus concerns inter alia, without being limited thereto, the following aspects:

1. A computer system for creating custom-made corrugated edge protectors, comprising: one or more processors; and one or more computer-readable media having stored thereon executable instructions that when executed by the one or more processors configure the computer system to perform at least the following: receive one or more product protection variables, wherein the one or more product protection variables comprise one or more of the following: a product dimension, a product fragility rating, or a product weight; determine one or more corrugated edge protector attributes based upon the one or more product protection variables, wherein the one or more corrugated edge protector attributes comprise one or more of the following: a corrugated type, a number of internal support members, or a dimension of a corrugated channel; generate a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping or handling; and send the construction command to the packaging production machine, the construction command causing the packaging production machine to create the custom-made corrugated edge protector.

2. The computer system according to preceding aspect 1, wherein the executable instructions include instructions that are executable to configure the computer system to: scan a barcode associated with the target product; access a database of item characteristics using the barcode; and receive the one or more product protection variables from the database.

3. The computer system according to preceding aspects 1 and 2, wherein determining the one or more corrugated edge protector attributes based upon the one or more product protection variables comprises: identifying a set of available corrugated types, wherein each corrugated type within the set of available corrugated types comprises unique strength characteristics; mapping a weight of the target product to a particular corrugated type based upon a set of corrugated strength thresholds; and incorporate the particular corrugated type within the one or more corrugated edge protector attributes.

4. The computer system according to preceding aspects 1-3, wherein determining the one or more corrugated edge protector attributes based upon the one or more product protection variables comprises: mapping the product fragility rating to a particular number of internal support members; and incorporating the particular number of internal support members within the one or more corrugated edge protector attributes.

5. The computer system according to preceding aspects 1-4, wherein the particular number of internal support members comprises a number of internal z-folds within a channel of the custom-made corrugated edge protector.

6. The computer system according to preceding aspects 1-5, wherein the particular number of internal support members comprises a number of strips of corrugated within a channel of the custom-made corrugated edge protector.

7. The computer system according to preceding aspects 1-6, wherein generating the construction command that is configured to cause the packaging production machine to create the custom-made corrugated edge protector comprises: receive dimensions describing a perimeter of the target product, wherein the perimeter comprises at least a first product length of a first side of the target product and a second product length of a second side of the target product, the second side being consecutive to the first side; calculating a first corrugated edge protector length that is greater than the first product length and a second corrugated edge protector length that is less than or equal to the second product length; and wherein: the first corrugated edge protector length describes a length of a first channel of the custom-made corrugated edge protector, and the second corrugated edge protector length describes a length of a second channel of the custom-made corrugated edge protector.

8. The computer system according to preceding aspects 1-7, wherein multiple, distinct custom-made corrugated edge protectors are placed around the target product.

9. The computer system according to preceding aspects 1-8, wherein generating the construction command comprises including at least one height measurement that causes the packaging production machine to create a custom-made corrugated edge protector of a particular height, wherein the at least one height measurement is based upon a height of the target product.

10. The computer system according to preceding aspects 1-9, wherein the target product comprises a tabletop and the custom-made corrugated edge protector comprises four physically separate corrugated channels that each extend along a length of a side of the tabletop.

11. A method for creating custom-made corrugated edge protectors, the method executed on one or more processors, the method comprising: receiving one or more product protection variables, wherein the one or more product protection variables comprise one or more of the following: a product dimension, a product fragility rating, or a product weight; determining one or more corrugated edge protector attributes based upon the one or more product protection variables, wherein the one or more corrugated edge protector attributes comprise one or more of the following: a corrugated type, a number of internal support members, or a dimension of a corrugated channel; generating a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping; and sending the construction command to the packaging production machine, the construction command causing the packaging production machine to create the custom-made corrugated edge protector.

12. The method according to preceding aspect 11, further comprising: scanning a barcode associated with the target product; accessing a database of item characteristics using the barcode; and receiving the one or more product protection variables from the database.

13. The method according to preceding aspects 11-12, wherein determining the one or more corrugated edge protector attributes based upon the one or more product protection variables comprises: identifying a set of available corrugated types, wherein each corrugated type within the set of available corrugated types comprises unique strength characteristics; mapping a weight of the target product to a particular corrugated type based upon a set of corrugated strength thresholds; and incorporating the particular corrugated type within the one or more corrugated edge protector attributes.

14. The method according to preceding aspects 11-13, wherein determining the one or more corrugated edge protector attributes based upon the one or more product protection variables comprises: mapping the product fragility rating to a particular number of internal support members; and incorporating the particular number of internal support members within the one or more corrugated edge protector attributes.

15. The method according to preceding aspects 11-14, wherein the particular number of internal support members comprises a number of internal z-folds within a channel of the custom-made corrugated edge protector.

16. The method according to preceding aspects 11-15, wherein the particular number of internal support members comprises a number of strips of corrugated within a channel of the custom-made corrugated edge protector.

17. The method according to preceding aspects 11-16, wherein generating the construction command that is configured to cause the packaging production machine to create the custom-made corrugated edge protector comprises: receive dimensions describing a perimeter of the target product, wherein the perimeter comprises at least a first product length of a first side of the target product and a second product length of a second side of the target product, the second side being consecutive to the first side; calculating a first corrugated edge protector length that is greater than the first product length and a second corrugated edge protector length that is less than or equal to the second product length; and wherein: the first corrugated edge protector length describes a length of a first channel of the custom-made corrugated edge protector, and the second corrugated edge protector length describes a length of a second channel of the custom-made corrugated edge protector.

18. The method according to preceding aspects 11-17, wherein multiple, distinct custom-made corrugated edge protectors are placed around target product.

19. The method according to preceding aspects 11-18, wherein generating the construction command comprises including at least one height measurement that causes the packaging production machine to create a custom-made corrugated edge protector of a particular height, wherein the at least one height measurement is based upon a height of the target product.

20. A computer program product comprising one or more computer storage media having stored thereon computer-executable instructions that, when executed at a processor, cause the computer system to perform a method for creating custom-made corrugated edge protectors, the computer-executable instructions configuring the processor to: receive one or more product protection variables, wherein the one or more product protection variables comprise one or more of the following: a product dimension, a product fragility rating, or a product weight; determine one or more corrugated edge protector attributes based upon the one or more product protection variables, wherein the one or more corrugated edge protector attributes comprise one or more of the following a corrugated type, a number of internal support members, or a dimension of a corrugated channel; generate a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping; and send the construction command to the packaging production machine, the construction command causing the packaging production machine to create the custom-made corrugated edge protector.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for creating custom-made corrugated edge protectors, comprising:
one or more processors; and
one or more computer-readable media having stored thereon executable instructions that when executed by the one or more processors configure the computer system to perform at least the following:
receive one or more product protection variables, wherein the one or more product protection variables comprise one or more of the following: a product dimension, a product fragility rating, or a product weight;
determine one or more corrugated edge protector attributes based upon the one or more product protection variables, wherein the one or more corrugated edge protector attributes comprise one or more of the following: a corrugated type, a number of internal support members, or a dimension of a corrugated channel;
generate a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping or handling; and
send the construction command to the packaging production machine, the construction command causing the packaging production machine to create the custom-made corrugated edge protector.

2. The computer system of claim 1, wherein the executable instructions include instructions that are executable to configure the computer system to:
scan a barcode associated with the target product;
access a database of item characteristics using the barcode; and
receive the one or more product protection variables from the database.

3. The computer system of claim 1, wherein determining the one or more corrugated edge protector attributes based upon the one or more product protection variables comprises:
identifying a set of available corrugated types, wherein each corrugated type within the set of available corrugated types comprises unique strength characteristics;
mapping a weight of the target product to a particular corrugated type based upon a set of corrugated strength thresholds; and
incorporate the particular corrugated type within the one or more corrugated edge protector attributes.

4. The computer system of claim 1, wherein determining the one or more corrugated edge protector attributes based upon the one or more product protection variables comprises:
mapping the product fragility rating to a particular number of internal support members; and
incorporating the particular number of internal support members within the one or more corrugated edge protector attributes.

5. The computer system of claim 4, wherein the particular number of internal support members comprises a number of internal z-folds within a channel of the custom-made corrugated edge protector.

6. The computer system of claim 4, wherein the particular number of internal support members comprises a number of strips of corrugated within a channel of the custom-made corrugated edge protector.

7. The computer system of claim 1, wherein generating the construction command that is configured to cause the packaging production machine to create the custom-made corrugated edge protector comprises:
receive dimensions describing a perimeter of the target product, wherein the perimeter comprises at least a first product length of a first side of the target product and a second product length of a second side of the target product, the second side being consecutive to the first side;
calculating a first corrugated edge protector length that is greater than the first product length and a second corrugated edge protector length that is less than or equal to the second product length; and
wherein:
the first corrugated edge protector length describes a length of a first channel of the custom-made corrugated edge protector, and
the second corrugated edge protector length describes a length of a second channel of the custom-made corrugated edge protector.

8. The computer system of claim 7, wherein multiple, distinct custom-made corrugated edge protectors are placed around the target product.

9. The computer system of claim 1, wherein generating the construction command comprises including at least one height measurement that causes the packaging production machine to create a custom-made corrugated edge protector of a particular height, wherein the at least one height measurement is based upon a height of the target product.

10. The computer system of claim 1, wherein the target product comprises a tabletop and the custom-made corrugated edge protector comprises four physically separate corrugated channels that each extend along a length of a side of the tabletop.

11. A method for creating custom-made corrugated edge protectors, the method executed on one or more processors, the method comprising:
receiving one or more product protection variables, wherein the one or more product protection variables comprise one or more of the following: a product dimension, a product fragility rating, or a product weight;
determining one or more corrugated edge protector attributes based upon the one or more product protection variables, wherein the one or more corrugated edge protector attributes comprise one or more of the following: a corrugated type, a number of internal support members, or a dimension of a corrugated channel;
generating a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping; and
sending the construction command to the packaging production machine, the construction command causing the packaging production machine to create the custom-made corrugated edge protector.

12. The method of claim 11, further comprising:
scanning a barcode associated with the target product;
accessing a database of item characteristics using the barcode; and
receiving the one or more product protection variables from the database.

13. The method of claim 11, wherein determining the one or more corrugated edge protector attributes based upon the one or more product protection variables comprises:
identifying a set of available corrugated types, wherein each corrugated type within the set of available corrugated types comprises unique strength characteristics;
mapping a weight of the target product to a particular corrugated type based upon a set of corrugated strength thresholds; and
incorporating the particular corrugated type within the one or more corrugated edge protector attributes.

14. The method of claim 11, wherein determining the one or more corrugated edge protector attributes based upon the one or more product protection variables comprises:
mapping the product fragility rating to a particular number of internal support members; and
incorporating the particular number of internal support members within the one or more corrugated edge protector attributes.

15. The method of claim 14, wherein the particular number of internal support members comprises a number of internal z-folds within a channel of the custom-made corrugated edge protector.

16. The method of claim 14, wherein the particular number of internal support members comprises a number of strips of corrugated within a channel of the custom-made corrugated edge protector.

17. The method of claim 11, wherein generating the construction command that is configured to cause the packaging production machine to create the custom-made corrugated edge protector comprises:
receive dimensions describing a perimeter of the target product, wherein the perimeter comprises at least a first product length of a first side of the target product and a second product length of a second side of the target product, the second side being consecutive to the first side;
calculating a first corrugated edge protector length that is greater than the first product length and a second corrugated edge protector length that is less than or equal to the second product length; and
wherein:
the first corrugated edge protector length describes a length of a first channel of the custom-made corrugated edge protector, and
the second corrugated edge protector length describes a length of a second channel of the custom-made corrugated edge protector.

18. The method of claim 17, wherein multiple, distinct custom-made corrugated edge protectors are placed around a target product.

19. The method of claim 11, wherein generating the construction command comprises including at least one height measurement that causes the packaging production machine to create a custom-made corrugated edge protector of a particular height, wherein the at least one height measurement is based upon a height of the target product.

20. A computer program product comprising one or more computer storage media having stored thereon computer-executable instructions that, when executed at a processor, cause a computer system to perform a method for creating custom-made corrugated edge protectors, the computer-executable instructions configuring the processor to:
receive one or more product protection variables, wherein the one or more product protection variables comprise one or more of the following: a product dimension, a product fragility rating, or a product weight;
determine one or more corrugated edge protector attributes based upon the one or more product protection variables, wherein the one or more corrugated edge protector attributes comprise one or more of the following a corrugated type, a number of internal support members, or a dimension of a corrugated channel;
generate a construction command that is configured to cause a packaging production machine to create a custom-made corrugated edge protector, wherein the construction command comprises instructions that are based upon the one or more corrugated edge protector attributes and the custom-made corrugated edge protector is configured to protect one or more edges of a target product during shipping; and
send the construction command to the packaging production machine, the construction command causing the packaging production machine to create the custom-made corrugated edge protector.
